(19) United States
(12) Patent Application Publication
(10) Pub. No.: US 2013/0230285 A1
(43) Pub. Date: Sep. 5, 2013

(54) OPTICAL FIBER CONNECTION ARCHITECTURE

(71) Applicant: SKORPIOS TECHNOLOGIES, INC., Albuquerque, NM (US)

(72) Inventors: Trever Skilnick, Albuquerque, NM (US); Timothy Creazzo, Albuquerque, NM (US)

(73) Assignee: SKORPIOS TECHNOLOGIES, INC., Albuquerque, NM (US)

(21) Appl. No.: 13/767,310

(22) Filed: Feb. 14, 2013

Related U.S. Application Data
(60) Provisional application No. 61/599,295, filed on Feb. 15, 2012.

(51) Int. Cl. G02B 6/42

(52) U.S. Cl. CPC G02B 6/4248
USPC 385/93; 385/92

(57) ABSTRACT

An optical fiber package includes a housing having a plurality of walls. One of the walls includes a via passing therethrough. The optical fiber package also includes an optical fiber mounted in the housing and extending through at least a portion of the via and a connector. The connector has a first portion mounted in the via. The optical fiber passes through the first portion. The connector also has a second portion extending outside the housing and including a collar operable to receive a male protrusion of an external fiber.

### CROSS-REFERENCES TO RELATED APPLICATIONS

This application claims priority to U.S. Provisional Patent Application No. 61/599,295, entitled “Optical Fiber Connection Architecture,” filed on Feb. 15, 2012, the disclosure of which is hereby incorporated by reference in its entirety for all purposes.

### BACKGROUND OF THE INVENTION

An optical fiber connector is used to terminate the end of an optical fiber and enables quicker connection and disconnection from optical components than achieved using splicing. The connectors provide mechanically coupling and optical alignment to optical components, enabling light to pass from the optical fiber to the optical component with reduced loss.

Despite the progress made in relation to optical fiber connectors, there is a need in the art for improved methods and systems related to optical fiber connectors.

### SUMMARY OF THE INVENTION

Embodiments of the present invention relate to methods and systems used in optical communications. More particularly, embodiments of the present invention relate to methods and apparatus for providing optical fiber connections. Embodiments of the present invention have wider applicability than this example and also include other applications for providing for optical connections between optical components.

According to an embodiment of the present invention, an optical fiber package is provided. The optical fiber package includes a housing having a plurality of walls. One of the walls includes a via passing therethrough. The optical fiber package also includes an optical fiber mounted in the housing and extending through at least a portion of the via and a connector. The connector has a first portion mounted in the via. The optical fiber passes through the first portion. The connector also has a second portion extending outside the housing and including a collar operable to receive a male protrusion of an external fiber.

According to another embodiment of the present invention, an optical fiber connector is provided. The optical fiber connector includes a protrusion operable to pass through a via of a package and a flange laterally disposed with respect to the protrusion and operable to couple to a wall of the package. The optical fiber connector also includes an optical fiber element passing through the protrusion and a receiver coupled to the flange and extending away from the wall of the package. The optical fiber connector further includes a collar aligned with the optical fiber element and extending away from the optical fiber element. The collar is operable to receive a male tip of an external fiber.

According to an embodiment of the present invention, an optical fiber connection of the optical fiber to the waveguide and a precision assembly recess providing engagement, retention and alignment of an external connector to the optical fiber. The design and implementation of this optical fiber connection architecture can be referred to as the SK optical fiber connection architecture.

Some embodiments of the present invention enable an optical fiber to pass through the wall of a BGA package, thereby providing an optical connection to an external fiber. As described herein, an optical fiber connector is installed in the wall of the package and provides a female connection suitable to receive a male tip of the external fiber.

Numerous benefits are achieved by way of the present invention over conventional techniques. For example, embodiments of the present invention provide environmental control of the package atmosphere while enabling an external optical fiber to be optically coupled to optical elements located inside the package. These and other embodiments of the invention along with many of its advantages and features are described in more detail in conjunction with the text below and attached figures.

### BRIEF DESCRIPTION OF THE DRAWINGS

FIG. 1A illustrates a first simplified perspective view of an optical fiber connector on a BGA package according to an embodiment of the present invention;

FIG. 1B illustrates a second simplified perspective view of the optical fiber connector on a BGA package illustrated in FIG. 1A;

FIG. 2 is a simplified perspective cutaway view illustrating components of an optical fiber connector according to an embodiment of the present invention;

FIG. 3A illustrates a side view of an optical fiber connector according to a first embodiment of the present invention;

FIG. 3B illustrates a side view of an optical fiber connector according to a second embodiment of the present invention;

FIG. 3C illustrates a side view of an optical fiber connector according to a third embodiment of the present invention;

FIG. 3D is a magnified view of the lensed fiber stub utilized in the embodiment illustrated in FIG. 3C;

FIG. 4A is a simplified side view of an optical fiber connector and an optical patch cable in an uninstalled configuration according to an embodiment of the present invention;

FIG. 4B is a simplified side view of an optical fiber connector with a patch cord installed according to an embodiment of the present invention;

FIG. 5A illustrates a first simplified perspective view of a one piece optical fiber connector according to an embodiment of the present invention;

FIG. 5B illustrates a second simplified perspective view of the one piece optical fiber connector illustrated in FIG. 5A;

FIG. 6A illustrates a simplified perspective view of a first portion of a two piece optical fiber connector according to an embodiment of the present invention;

FIG. 6B illustrates a simplified perspective view of a second portion of a two piece optical fiber connector according to an embodiment of the present invention;

FIG. 7 is a magnified view of an optical fiber connector highlighting an alignment feature according to an embodiment of the present invention; and

FIG. 8 is a magnified view of the optical fiber connector illustrated in FIG. 7 with a patch cord installed according to an embodiment of the present invention.

### DETAILED DESCRIPTION OF SPECIFIC EMBODIMENTS

According to the present invention, methods and systems for connecting optical components are provided. More particularly, embodiments of the present invention relate to methods and apparatus for connecting an optical fiber to a package including optical elements. Embodiments of the present invention have wider applicability than this example and also include other applications for providing for optical connections between optical components.

The communications industry currently uses a wide variety of optical fiber connection types to interconnect modules for light transmission. Each connection includes an inherent degradation of the transmission, reducing ultimate performance. Multiple connections through these adapters can degrade or become inoperable, reducing the durability of the system. To achieve high-speed communications, a more direct and exact connection is utilized in making the connection to the optical module. In some implementations, reducing the number of interconnects and/or optical fiber pigtails will increase the robustness of the system.

The use of a single-mode optical fiber for communications exacerbates the issue of signal degradation of multiple connection locations due to the small diameter of the fiber and the higher requirement for precise alignment at the interconnect.

The coupling of an optical source to an optical fiber traditionally requires the use of two connectors incorporating male protrusions with optical fibers embedded and polished to provide the appropriate interconnecting surface. These two male protrusions meet tip-to-tip and are positioned relative to each other via a ferrule. Each component in the system has a manufacturing and assembly tolerance that allows the mating of the connectors within these wide range variations of the connectors themselves. However, this connection does not typically provide the coupling performance required for single-mode optical fiber communication associated with high transmission rates.

The design of the optical fiber connection architecture described herein (which may be referred to as an optical fiber connector) provides, in some embodiments, a direct connection of an external optical fiber through a single connector to an optical module. The optical fiber connection receiver is incorporated into the optical module package providing robustness and protection in comparison with conventional techniques. The optical fiber connection has inherent protection from EMI/EMC, since it is incorporated inside the optical module package boundaries.

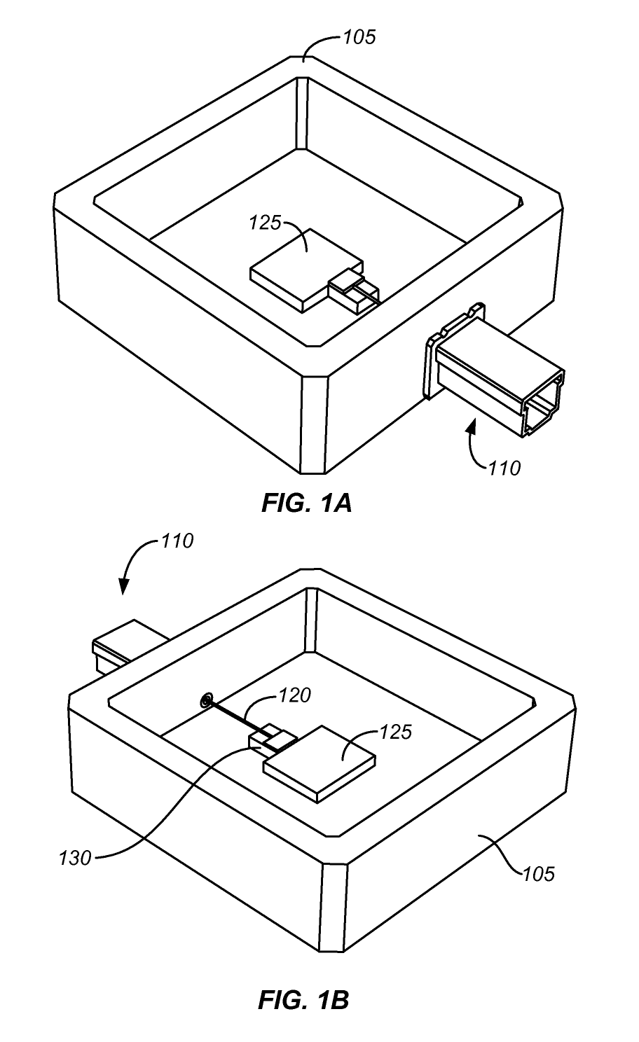

FIG. 1A illustrates a first simplified perspective view of an optical fiber connector on a BGA package according to an embodiment of the present invention. FIG. 1B illustrates a second simplified perspective view of the optical fiber connector on a BGA package illustrated in FIG. 1A. Although a BGA package is illustrated in FIGS. 1A and 1B, this particular type of package is not required and other package types, including through hole packages, surface mount packages, chip carrier packages, pin grid arrays, butterfly packages, and TO packages are included within the scope of the present invention.

Referring to FIGS. 1A and 1B, two views of the connector installed on a BGA package 105 are illustrated. In FIG. 1A, optical fiber connector 110 extends from the package 105. In FIG. 1B, the optical fiber 120 is illustrated as coupled to the device and running into the female optical fiber connector 110. According to embodiments of the present invention, a socketed connection on the side of the BGA package is provided by the illustrated optical fiber connector 110. This design contrasts with conventional packages in which a fiber pigtail is provided as a connection to the package.

The optical fiber connection includes an optical fiber 120 attached directly or indirectly to the chip/waveguide 125. The optical fiber can be a single mode fiber, a multi-mode fiber, or the like. In order to align the optical fiber 120 and the chip/waveguide 125, a v-groove and/or other alignment/retention/strain relief device for the optical fiber may be formed as part of a coupling element 130. Embodiments of the present invention are not limited to v-groove-based alignment and support devices. The optical fiber connector 110 can also be referred to as an optical union sleeve (OpUS) that is attached to the package exterior and provides a connection recess into which optical components are inserted as described more fully below. The optical fiber connector 110 provides a reinforced outlet to the exterior connector and can house one of multiple connection technologies to best pair the module to its usage.

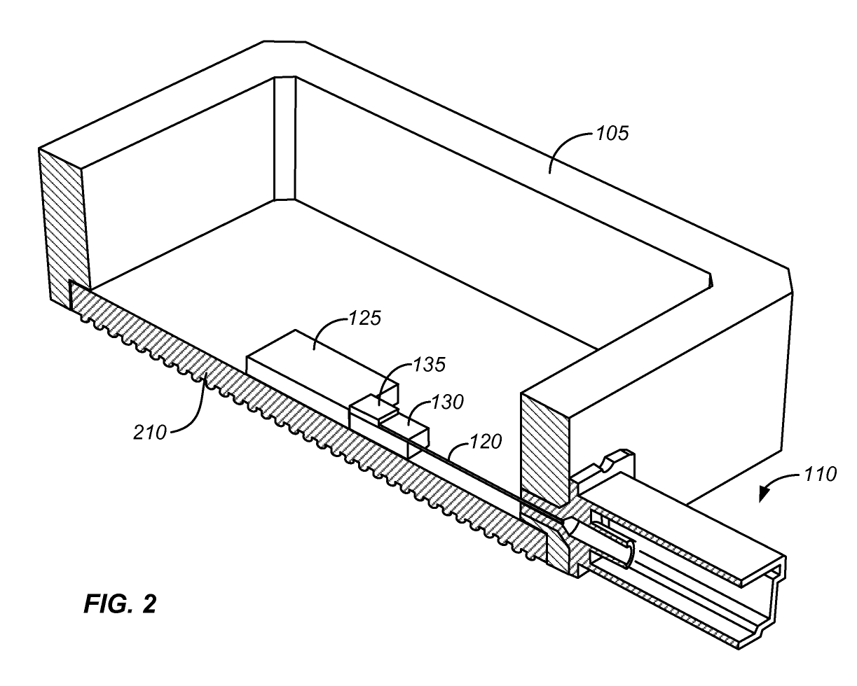

FIG. 2 is a simplified perspective cutaway view illustrating components of an optical fiber connector according to an embodiment of the present invention. As illustrated in FIG. 2, the optical fiber 120 is supported by the coupling element 130, which, in this embodiment, includes a v-groove that supports and aligns the fiber. A v-groove 135 is used to support the optical fiber and attach the optical fiber to the chip/waveguide 125 although this is not required by the present invention.

The chip/waveguide 125 as well as other optical elements is mounted on a substrate 210, which is illustrated as including a plurality of BGA connections on the lower surface. The substrate 210 forms the bottom surface of the BGA package 105 and is mounted to the package using suitable techniques. As described more fully throughout the present specification, the female connector 110 is mated to the BGA package 105, providing mechanical stability and/or environmental (e.g., hermetic) control for the package.

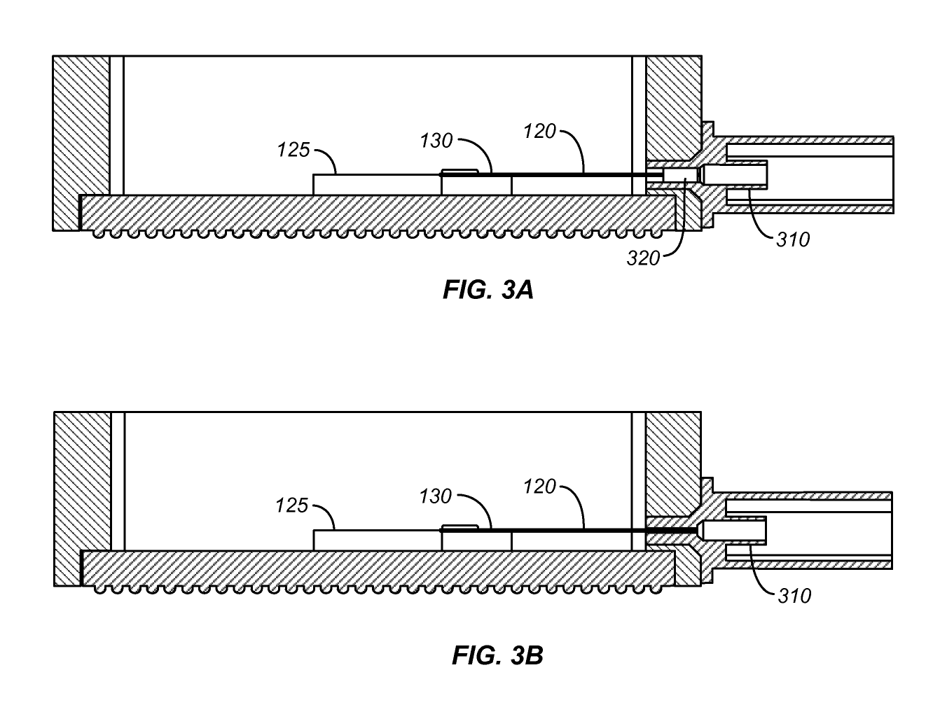

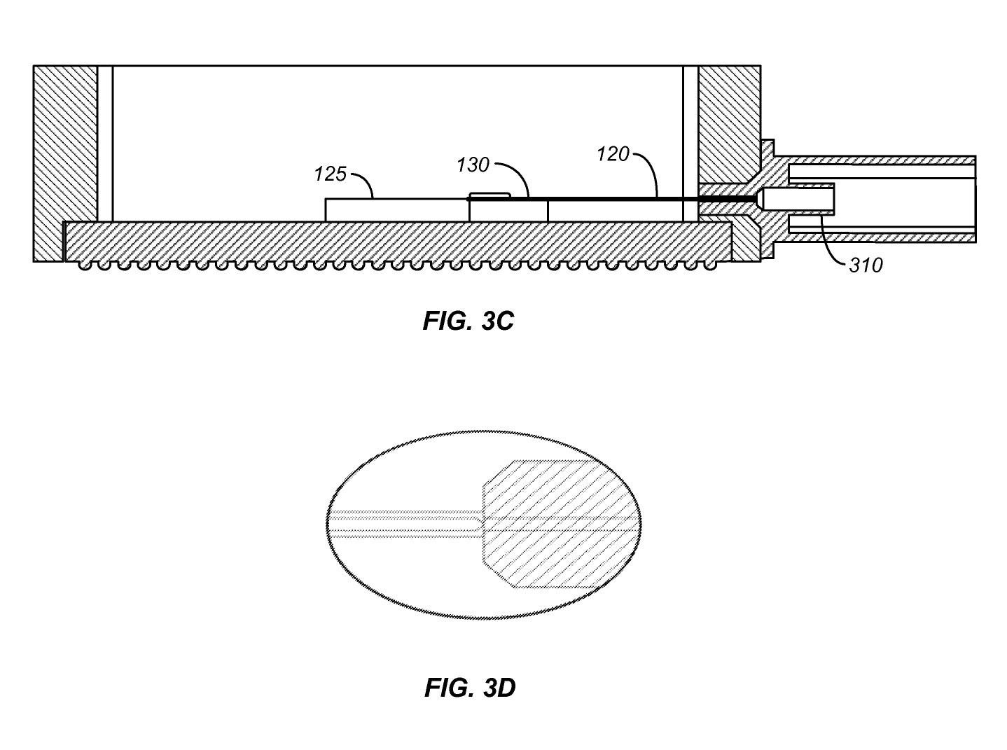

FIGS. 3A-3C illustrate side views of optical fiber connectors according to various embodiments of the present invention. These figures illustrate the incorporation of different internal connection technologies within the female connector 110. As illustrated, optical and mechanical connections are provided suitable for connection to external optical fibers, with three derivatives of the connector architecture illustrated.

In FIG. 3A, the female connector 110 includes an embedded GRIN lens integrated into the design. The chip 125, the v-groove 130, the fiber 120, the barrel structure 310, and the GRIN lens 320 are illustrated. The male protrusion coming from the receiving fiber (not shown) is directly coupled to the GRIN lens 320. In a conventional package, a male connector would be coupled to the GRIN lens and the male protrusion from the receiving fiber would be coupled to the male connector. According to this embodiment, the male connector is removed, with the receiving fiber directly coupled to the end of the fiber in the package through the GRIN lens.

In FIG. 3B, a direct fiber-to-fiber connection is provided by the illustrated embodiment. In FIG. 3C, a lensed fiber stub from the waveguide input/output is integrated into the connector. In this embodiment, the optical fiber 120 is disposed in a sleeve to form the lensed fiber stub. FIG. 3D is a magnified view of the lensed fiber stub utilized in the embodiment illustrated in FIG. 3C.

Although these three derivatives are illustrated, embodiments of the present invention are not limited to these derivatives and other modifications of the basic design are included within the scope of the present invention. Embodiments of the present invention provide benefits not available with conventional systems including the ability to connect single mode or multimode fibers with tight tolerance specifications. Additionally, because the male protrusion of the receiving fiber is coupled to the fiber in the optical connector package in some embodiments, the percentage of light transmitted between the fibers is increased.

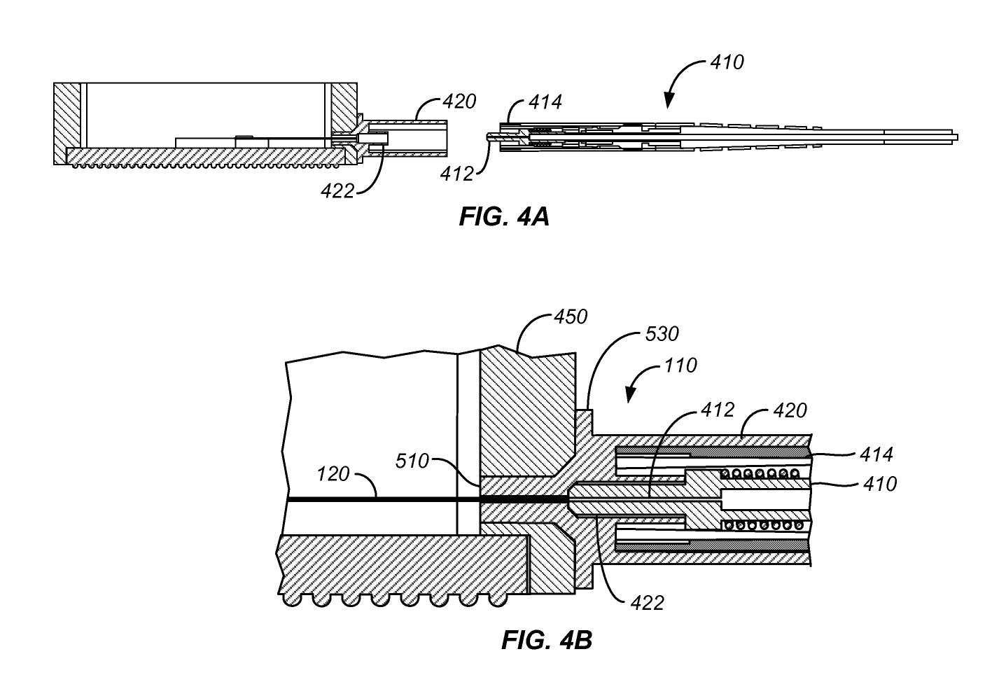

FIG. 4A is a simplified side view of an optical fiber connector and an optical patch cable in an uninstalled configuration according to an embodiment of the present invention. The cross section of the optical fiber connector is illustrated on the left portion of the figure, with an external fiber illustrated on the right portion of the figure. The external fiber 410 includes a male fiber tip 412 that extends from the end of housing 414. The outside dimensions of the housing 414 are matched to the inside dimensions of receiver 420 and the outside diameter of the male fiber tip 412 is matched to the inside diameter of collar 422. In some embodiments, the housing 414 can include flat or curved features including keying structures depending on the particular implementation. Referring to FIG. 2, the cross section of the receiver portion of the female connector 110 is visible, with a flat top section, a keying structure adjacent the top section, and a beveled lower portion. This design is merely exemplary and other cross sectional shapes are included within the scope of the present invention.

FIG. 4B is a simplified side view of an optical fiber connector with a patch cord installed according to an embodiment of the present invention. In this illustration, the external fiber 410 is inserted into female connector 110 with the housing 414 mated to the receiver 420 and the male fiber tip 412 mated to the collar 422. The housing/receiver mating provides for mechanical coupling and high level optical alignment. The male fiber tip/collar mating provides for precision optical alignment between the external fiber and the optical fiber 120.

Embodiments of the present invention provide methods and systems for connecting an external fiber to a package that includes a female connector with a receiver operable to receive a housing of the external fiber and an internal collar operable to receive a male fiber tip. The internal collar, attached to the package, enables optical coupling between the optical fiber mounted in the package and the external fiber.

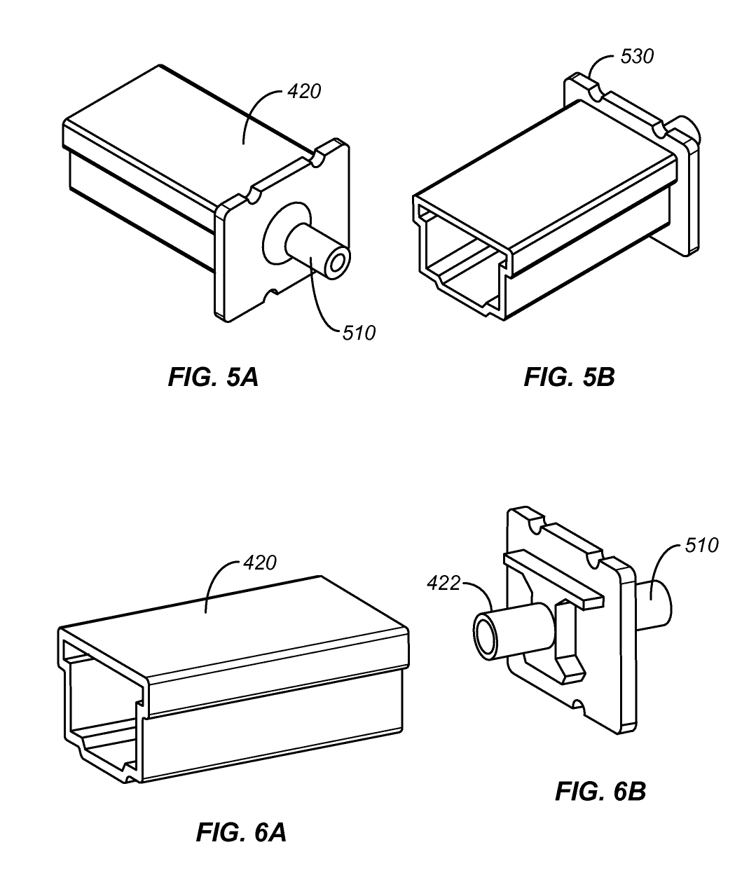

FIG. 5A illustrates a first simplified perspective view of a one piece optical fiber connector according to an embodiment of the present invention. FIG. 5B illustrates a second simplified perspective view of the one piece optical fiber connector illustrated in FIG. 5A. The one-piece optical fiber connector illustrated in FIGS. 5A and 5B include receiver 420 and protrusion 510 that is shaped to mate with a via passing through the wall of the housing 105. Referring to FIG. 4B, the protrusion 510 passes through the via extending through the wall 450 of the housing and surrounds the optical fiber. The optical fiber 120 passes through the protrusion 510 to the collar 422.

As illustrated in FIG. 5B, the receiver 420 and the portion of the female connector joined to the housing are manufactured separately and then combined to form the optical fiber connector. The collar 422 operable to receive the male tip of the external fiber as well as protrusion 510 are illustrated in FIG. 5B. A flange 530 is operable to mount against the outer surface of the wall 450 of the housing, providing environmental control over the atmosphere in the housing, for example, a hermetic seal.

The one-piece design can be implemented in applications for which the alignment and retention features suitable for connecting with the external transmission optical fiber can be economically manufactured in a single component. The two-piece design allows for more complex designs and/or multiple connection interfaces to be incorporated under the connector architecture. Thus, depending on the manufacturing cost and complexity issues, multiple options are provided by embodiments of the present invention for the optical fiber connector.

For the one-piece design, incorporating the female receiver and retention features for the male connector on the external fiber, the female connector 110 is aligned and affixed to the exterior wall of the package in as little as one manufacturing step. The exterior of the female connector includes a manufactured flange 530 that can be retained to the exterior wall 450 of the package by epoxy, welding, soldering, or other suitable technique. The manufactured flange may also include mechanical connectors or provisions for fasteners for positioning and/or retention to the exterior wall of the package. One of ordinary skill in the art would recognize many variations, modifications, and alternatives.

In a two-piece configuration, the inner portion of the optical fiber connector (illustrated in FIG. 6B) includes the internal optical connection technology associated to the connector, i.e., the collar 422 operable to receive the male tip of the external fiber. The optical fiber connector is aligned to the optical output fiber of the chip, independent of the exterior device packaging and affixed to the exterior package. The optical fiber connector can be retained to the exterior shell by a variety of retention technologies (such as epoxy, welding, or soldering) or a combination dependent on the overall design requirements. The optical fiber connector may also include mechanical connectors or provisions for fasteners for positioning and/or retention to the exterior package, either as a temporary retention or permanent retention. The external cavity incorporating the female recess and retention features for the male connector on the external (e.g., transmission) fiber, the receiver 420 is aligned to the inner portion illustrated in FIG. 6B and affixed using vibration welding and/or another mechanical retention technology.

Referring to FIGS. 6A and 6B, the two-piece design enables for separate alignment and bonding of the inner portion including the collar 422 and the receiver 420. As an example, the inner portion (also referred to as a fiber portion and illustrated in FIG. 6A) could be aligned to the package (e.g., the BGA package) and mounted with a first tolerance and the female connector portion illustrated in FIG. 6B could be aligned to the package and mounted with a second tolerance, providing for differing alignment precision as appropriate to the particular application.

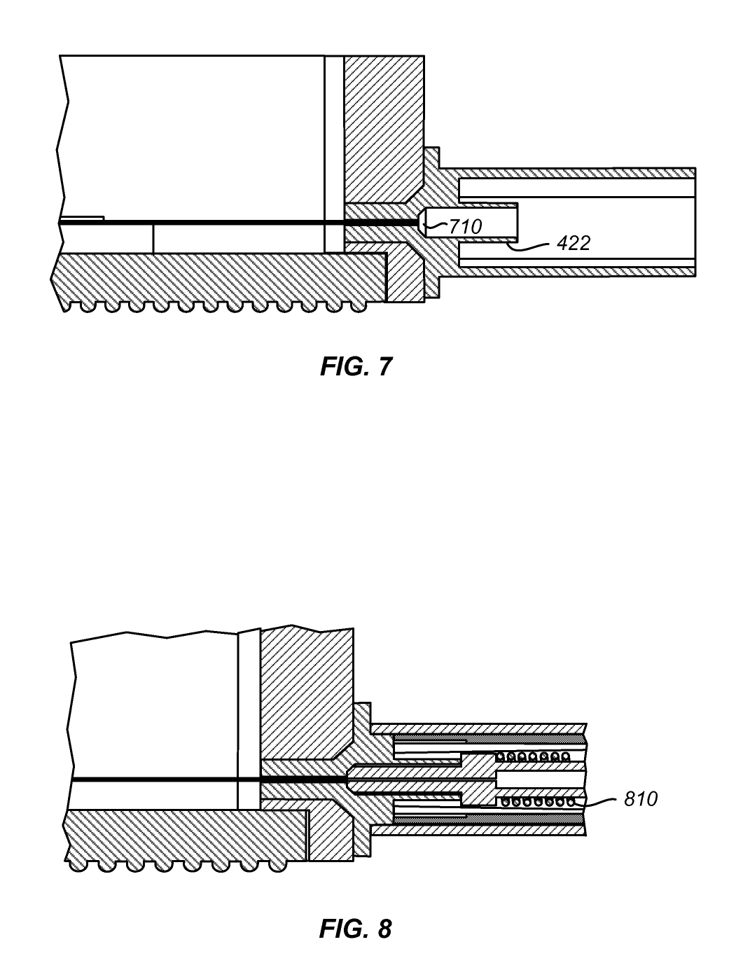

FIG. 7 is a magnified view of an optical fiber connector highlighting an alignment feature according to an embodiment of the present invention. As illustrated in FIG. 7, collar 422 includes a beveled edge 710 along the connecting optical fiber axis to accept the male protrusion from the receiving fiber and correctly align it with the output fiber of the package. The male tip of the external fiber will, in these implementations, have a matching beveled periphery to improve optical alignment.

FIG. 8 is a magnified view of the optical fiber connector illustrated in FIG. 7 with a patch cord installed according to an embodiment of the present invention. An axial spring 810 is provided within the connector to produce sufficient force to ensure alignment at the connector face.

As an example, in some embodiments, the manufacturing tolerance of the collar (also referred to as a receiving barrel), which can include the bevel 710, into which the receiving fiber is inserted, is precise as a result of the manufacturing process (e.g., EDM) and one-piece construction to reduce or eliminate the need for an alignment adjustment feature. As shown in FIG. 8, the spring 810 that is built into the connector provides forward pressure on the male protrusion so that it naturally follows the chamfer and automatically aligns to the optical fiber in the package.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An optical fiber package including:
a housing having a plurality of walls, one of the walls including a via passing therethrough;
an optical fiber mounted in the housing and extending through at least a portion of the via; and
a connector having:
a first portion mounted in the via, wherein the optical fiber passes through the first portion; and
a second portion extending outside the housing and including a collar operable to receive a male protrusion of an external fiber.

2. The optical fiber package of claim 1 wherein the second portion further comprises a receiver operable to receive a housing of the external fiber.

3. The optical fiber package of claim 1 wherein the optical fiber package comprises a Photonic Integrated Circuit package.

4. The optical fiber package of claim 1 wherein the optical fiber package comprises at least one of a BGA package, a SCSP package, a Flip Chip BGA package, a Flip Chip CSP package, or a Super Flip Chip package (FCBGA, fcCSP, SuperFC, or fcLGA).

5. The optical fiber package of claim 1 wherein the optical fiber in the optical fiber package is optically connected to an optical element.

6. The optical fiber package of claim 5 wherein the optical element comprises a Photonic Integrated Circuit.

7. The optical fiber package of claim 5 wherein the optical element comprises at least one of an LED, a modulator, a laser, or a detector.

8. The optical fiber package of claim 1 wherein a GRIN lens is mounted in the connector between the optical fiber and the collar.

9. The optical fiber package of claim 1 wherein the collar is concentric with the optical fiber.

10. The optical fiber package of claim 1 wherein the optical fiber package comprises at least one of a direct straight fiber, a tapered fiber, or a fiber with an attached GRIN lens.

11. An optical fiber connector including:
a protrusion operable to pass through a via of a package;
a flange laterally disposed with respect to the protrusion and operable to couple to a wall of the package;
an optical fiber element passing through the protrusion;
a receiver coupled to the flange and extending away from the wall of the package; and
a collar aligned with the optical fiber element and extending away from the optical fiber element, wherein the collar is operable to receive a male tip of an external fiber.

12. The optical fiber connector of claim 11 wherein the receiver is operable to receive a housing of the external fiber.

13. The optical fiber connector of claim 11 wherein the package comprises a BGA package.

14. The optical fiber connector of claim 11 further comprising a GRIN lens disposed in the protrusion between the optical fiber element and the collar.

15. The optical fiber connector of claim 11 wherein the collar is concentric with the optical fiber element.
